(19) United States
(12) Patent Application Publication
(10) Pub. No.: US 2008/0120808 A1
(43) Pub. Date: May 29, 2008

(54) Limited travel hinge

(76) Inventor: Ting-Hsien Wang, Shulin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/605,470

(22) Filed: Nov. 29, 2006

(51) Int. Cl. E05D 11/06

(52) U.S. Cl. 16/332

(57) ABSTRACT

A limited travel hinge has a pintle, a leaf and a limit. The pintle has an inner end connected securely to a base of a portable electronic device. The leaf has a stop, is mounted pivotally on the pintle, connects securely to a panel of the electronic device that allows the panel to pivot relative to the base. The limit is mounted securely on the pintle and has a recessed edge defined partially around the limit, is mounted slidably against the stop of the leaf and has two ends corresponding to and selectively abutting the stop. With such an arrangement, the limited travel hinge is simple and is assembled easily, which effectively reduces the cost and facilitates fabrication.

### BACKGROUND OF THE INVENTION

1. Field of the Invention

The present invention relates to a hinge, and more particularly to a limited travel hinge that is simple and is fabricated easily.

2. Description of Related Art

A portable electronic device such as a notebook computer or a smart phone generally includes a panel, a base and a hinge. Typically, the hinge is mounted between the panel and the base to allow the panel to pivot relative to the base and facilitate looking at the panel.

To keep the panel from pivoting excessively and being damaged, the hinges have been further designed with a limited travel hinge. Accordingly, a conventional limited travel hinge mainly comprises a pintle, two leaves and multiple limiting elements. The leaves are mounted pivotally on the pintle, are connected securely respectively to the panel and the base and allow the panel to pivot relative to the base. The limiting elements are mounted on the pintle adjacent to each other and respectively have at least one stop and to abut each other and limit how much the panel will pivot to a determined angle.

However, conventional limited travel hinges have many limiting elements that inevitably result in high-cost. Moreover, the limiting elements have to be mounted at right angles to the pintles, so fabricating and assembling the conventional limited travel hinges may become more difficult and time-consuming.

To overcome the shortcomings, the present invention provides a limited travel hinge to obviate or mitigate the aforementioned problems.

### SUMMARY OF THE INVENTION

The main objective of the present invention is to provide a limited travel hinge that is simple and is easy to fabricate.

To achieve the objective, the limited travel hinge in accordance with present invention comprises a pintle, a leaf and a limit. The pintle has an inner end connected securely to a base of a portable electronic device. The leaf has a stop, is mounted pivotally on the pintle, connects securely to a panel of the electronic device that allows the panel to pivot relative to the base. The limit is mounted securely on the pintle and has a recessed edge. The recessed edge is defined partially around the limit, is mounted slidably against the stop of the leaf and has two ends corresponding to and selectively abutting the stop on the leaf to limit rotation of the leaf.

With such an arrangement, the limited travel hinge is simple and is assembled easily so the cost of assembly is effectively reduced and fabrication is facilitated.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a limited travel hinge in accordance with the present invention;

FIG. 2 is a partially exploded perspective view of the hinge in FIG. 1;

FIG. 3 is a front view of the hinge in FIG. 1;

FIG. 4 is a partially exploded perspective view of a second embodiment of a limited travel hinge in accordance with the present invention;

FIG. 5 is a front view of the hinge in FIG. 4;

FIG. 6 is an enlarged operational side view of the hinge in FIG. 1 in a closed position; and

FIG. 7 is an enlarged operational side view of the hinge in FIG. 1 opened to a maximum limit.

### DETAILED DESCRIPTION OF THE PREFERRED EMBODIMENT

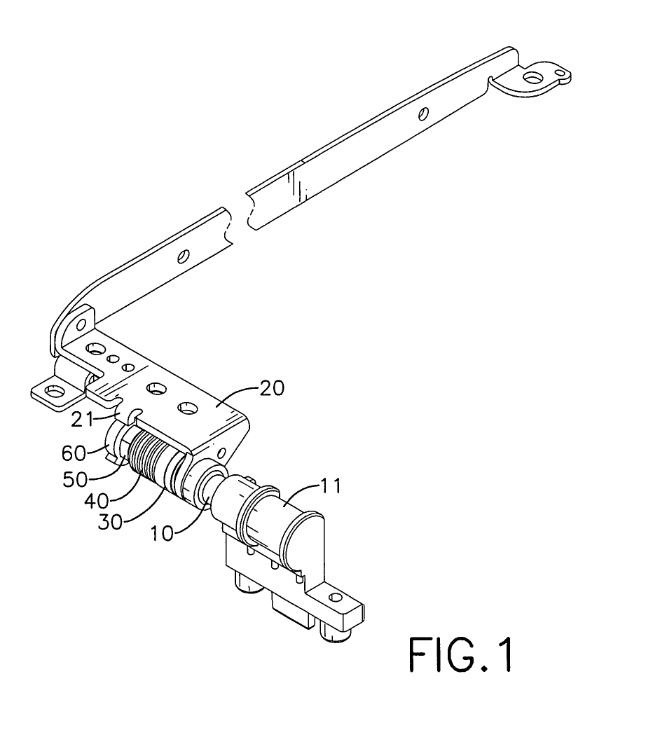

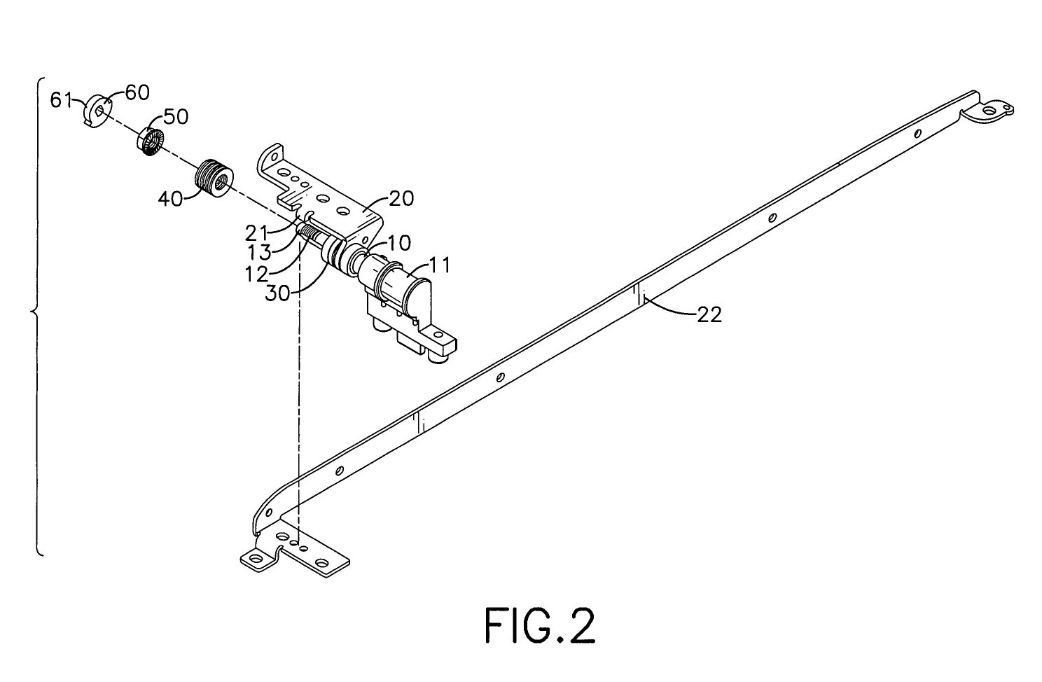

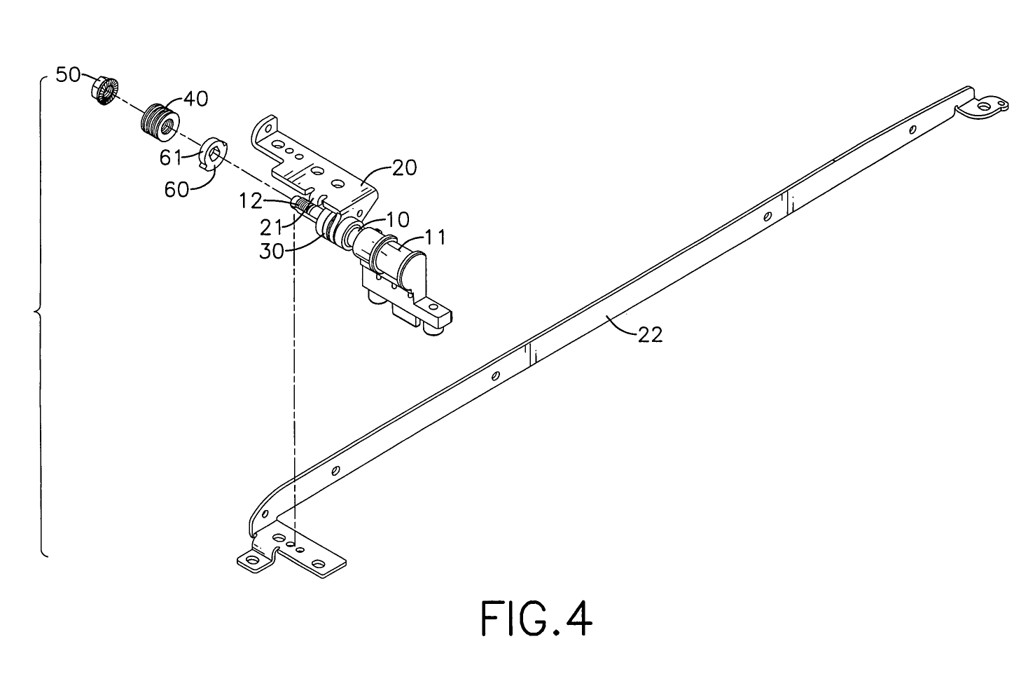

With reference to FIGS. 1, 2 and 4, the limited travel hinge in accordance with present invention comprises a pintle (10), a leaf (20), at least one washer (30), a resilient assembly (40), a fastener (50) and a limit (60).

The pintle (10) has a diameter, an outer end, an inner end, a keyed rod (13), an optional external thread (12) and an optional bracket (11). The keyed rod (13) is formed coaxially on the pintle (10), extends away from the outer end, is smaller than the pintle (10) and has a diameter and a distal end. The external thread (12) is formed around the pintle (10) near the keyed rod (13). The bracket (11) is connected securely to the inner end of the pintle (10) and is mounted securely in a base of an electronic device to connect the pintle (10) to the base of the electronic device.

The leaf (20) is mounted pivotally around the pintle (10) parallel to the pintle (10) has a proximal end, a distal end, a mounting tab, an edge, a stop (21) and an optional leaf extension (22). The mounting tab is formed on and protrudes perpendicular from the proximal end of the leaf (20) and is mounted pivotally around the pintle (10). The stop (21) is formed on and protrudes out and down from the edge of the leaf (20) toward the keyed rod (13) on the pintle (10) and has a distal end. The leaf extension (22) is attached to the leaf (20), extends transversely relative to the pintle (10) and is connected securely to a panel of the portable electronic device to make the panel pivot stably relative to the base.

The washer (30) is mounted around the pintle (10) against the mounting tab of the leaf (20) and provides friction to hold the leaf (20) in position.

The resilient assembly (40) is mounted around the pintle (10) and presses the washer (30) against the mounting tab of the leaf (20).

The fastener (50) may be a nut, is mounted adjustably on the pintle (10) against the resilient assembly (40), presses the resilient assembly (40) against the washer (30) to control the friction between the washer (30) and the mounting tab on the leaf (20) and has a central hole. The central hole is mounted on the external thread (12) of the pintle (10) and may have an internal thread.

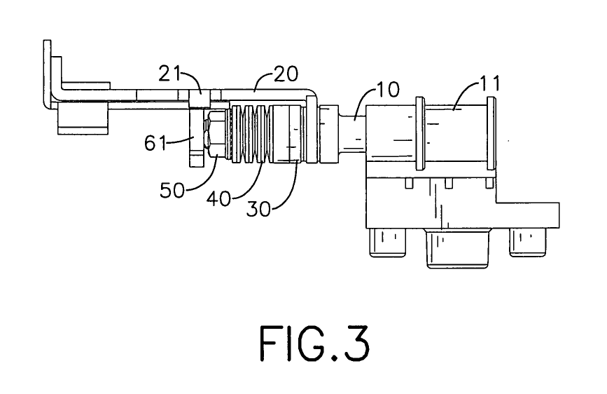

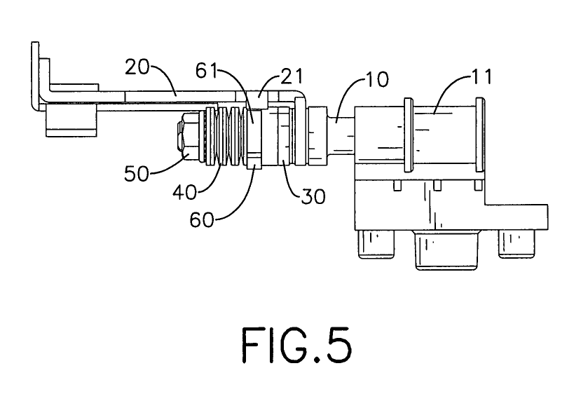

With further reference to FIGS. 3 and 5, the limit (60) is mounted securely on the keyed rod (13) of the pintle (10), may be mounted at the distal end of the keyed rod (13) or between the washer (30) and the resilient assembly (40) and has a central keyed hole, a recessed edge (61) and a protruding edge. The central keyed hole corresponds to and is mounted on the keyed rod (13) to keep the limit (60) from rotating relative to the pintle (10). The recessed edge (61) determines how much the leaf (20) will pivot relative to the pintle (10), is mounted slidably against the distal end of the stop (21) of the leaf (20) and has a specific length and two ends corresponding to and selectively abutting the stop (21). The protruding edge is formed between the ends of the recessed edge (61).

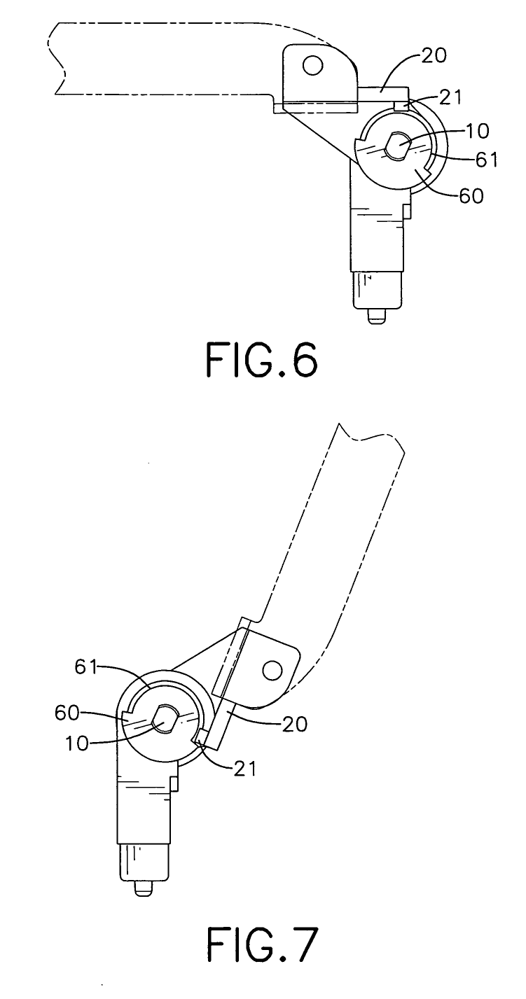

With further reference to FIGS. 6 and 7, the leaf extension (22) and the leaf (20) can be pivoted relative to the pintle (10) when the stop (21) is sliding against the recessed edge (61) between the ends of the protruding edge to limit rotation of the leaf (20) to a specific angle.

With such an arrangement, the limited travel hinge is simple and is assembled easily, which effectively reduces the cost and facilitates fabrication.

Even though numerous characteristics and advantages of the present invention have been set forth in the foregoing description together with details of the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

What is claimed is:

1. A limited travel hinge comprising
a pintle having
an inner end; and
an outer end;
a leaf being mounted pivotally around the pintle parallel to the pintle and having
a proximal end;
a distal end;
an edge; and
a stop being formed on and protruding out from the edge of the leaf toward the pintle and having a distal end;
at least one washer being mounted around the pintle against the leaf;
a resilient assembly being mounted around the pintle and pressing the washer against the leaf;
a fastener being mounted adjustably on the pintle against the resilient assembly and pressing the resilient assembly against the washer; and
a limit being mounted on and rotating with the pintle and having
a central keyed hole corresponding to and being mounted on the pintle;
a recessed edge determining how much the leaf will pivot relative to the pintle, being mounted slidably against the distal end of the stop of the leaf and having
a specific length; and
two ends corresponding to and selectively abutting the stop of the leaf.

2. The limited travel hinge as claimed in claim 1, wherein the pintle further has a keyed rod being formed coaxially on the pintle, extending away from the outer end and having a distal end; and
the limit is mounted at the distal end of the keyed rod.

3. The limited travel hinge as claimed in claim 1, wherein the pintle further has a keyed rod being formed coaxially on the pintle, extending away from the outer end and having a distal end; and
the fastener further has a central hole mounted on the distal end of the keyed rod of the pintle; and
the limit is mounted between the washer and the resilient assembly.

4. The limited travel hinge as claimed in claim 3, wherein the diameter of the keyed rod is smaller than the diameter of the pintle.

5. The limited travel hinge as claimed in claim 4, wherein the pintle further has a bracket connected securely to the inner end of the pintle.

6. The limited travel hinge as claimed in claim 5, wherein the leaf further has a leaf extension attached to the leaf and extending transversely relative to the pintle.

7. The limited travel hinge as claimed in claim 6, wherein
the pintle further has an external thread formed around the pintle near the keyed rod; and
the fastener is a nut has a central hole having an internal thread screwing onto the external thread of the pintle.

8. The limited travel hinge as claimed in claim 1, wherein the pintle and the central keyed hole of the limit are non-circular in cross section.
